(19) United States
(12) Patent Application Publication
(10) Pub. No.: US 2011/0033228 A1
(43) Pub. Date: Feb. 10, 2011

(54) Welded Ball Pin and Method for the Production Thereof

(75) Inventor: Robert Bongartz, Neuss (DE)

Correspondence Address: CLARK HILL PLC, 150 NORTH MICHIGAN AVENUE, SUITE 2700, CHICAGO, IL, 60601, US

(73) Assignee: ACUMENT GMBH & CO. OHG, Neuwied (DE)

(21) Appl. No.: 12/937,487

(22) PCT Filed: May 8, 2009
(86) PCT No.: PCT/DE2009/050023

§ 371 Date: Oct. 12, 2010

(30) Foreign Application Priority Data
May 15, 2008 (DE) 20 2008 006 650.6

(51) Int. Cl. F16B 1/00; B23K 20/00; B29C 65/00

(52) U.S. Cl. 403/270; 228/101; 156/60

(57) ABSTRACT

The invention relates to a welded ball pin (10) including a shaft (14; 14′) on which a completely closed ball (12) is welded, wherein the shaft (14; 14′) is configured as a hollow cylinder and an inner wall of the shaft (14′) is provided with grooves (24) extending parallel to a rotation axis of the shaft (14′).

The invention relates to welded ball pins and to methods for the production thereof.

Ball pins are preferably used where one or two components have to be movably connected with one another.

Ball pins typically include a ball and a shaft. For welded ball bins the two components ball and shaft are connected by a welding process. In the prior art the shaft to which the ball is welded is typically made from cylindrical bar stock. Based on this geometry prior art ball pins typically have increased stress at the transition between ball and shaft and in the portion of the weld under alternating bending loads. Thus, in the prior art there is an increased risk for fracture of the weld in the transition portion which leads to total destruction of the welded ball pin.

With respect to such ball pins it had been previously attempted to prevent a fracture of the weld between the ball and the shaft. Thus, e.g. the DE-OS 23 00 670 has proposed to fabricate ball and shaft together from two respective halves, wherein one half respectively included a half sphere and a half of the hollow shaft and the two halves were then connected by welding.

This method, however, had the disadvantage that the concentricity of the ball was subsequently impaired by the circumferential weld. Furthermore this solution was not advantageous because the respective welding of the halves was very complex.

It is furthermore known from DD 278 175 A1 to provide the ball with a disc shaped accretion and to only apply a respective hollow cylindrical shaft at this accretion. This, however, requires a complex fabrication of the ball provided with the disc shaped accretion.

A similar solution is known from DE 856 256. Therein the balls are provided with a hollow accretion whose diameter corresponds to the shaft connected thereto, which is also configured hollow. This, however, causes relatively complex fabrication since a precise alignment of the ball with the hollow accretion is required with respect to the shaft.

The most proximal prior art with respect to the present invention, however, is described in DE 197 35 638 A1. This document already discloses a method for producing a ball pin and a respective ball pin, wherein the ball pin produced includes a substantially ball shaped upper portion and an essential rod shaped lower portion. Therein, however, the essential ball shaped element has to be provided with a suitable first contact surface and the disc shaped portion has to be provided with a suitable contact surface, so that the contact surfaces can be connected with one another through friction welding. However, also this increases the complexity in particular when producing the shaft which has to be provided with a respective camber, wherein when using balls with different diameters also a respectively different contact surface has to be fabricated.

Thus it is the object of the present invention to improve a welded ball pin of this type, so that it can be produced in a very simple manner and the weld does not have to be that highly loaded and the risk of fracture is reduced and it is another object of the invention to provide an improved manufacturing method for the welded ball pin.

According to the invention the geometry of the shaft was newly designed as required. According to the invention the shaft is configured as a hollow cylinder.

The hollow cylinder can partially bear the loads between ball and shaft in an elastic manner, thus it acts like a spring and therefore reduces tensions within the weld. This way the service life and load bearing capability of the weld are significantly increased. A desirable side effect is a significant reduction of the weight of the welded ball pin.

Through the configuration according to the invention with a hollow shaft tensions are transferred from the weld into the shaft which can thus act like a spring. Thus the welded ball pin according to the invention is not mostly loaded in the portion of the weld for an alternating bending load any more, but a dynamic alternating load is provided over the entire shaft portion. Thus, fracture formation in the weld in the ball-shaft transition is counteracted.

Thus, it is preferred in particular to provide the inner wall of the shaft with grooves extending parallel to the rotation axis of the shaft. This way, the fiber orientation in the material of the shaft can be aligned parallel and thus the elasticity and the bending fatigue of the shaft can be further improved.

Thus, it is preferred in particular when the depth of the grooves is selected greater than half the wall thickness of the hollow cylindrical shaft.

It is further preferred that the grooves include a semi circular cross section. Also here the elasticity of the shaft is improved.

It is furthermore preferred that the grooves extend almost over the entire length of the hollow cylindrical shaft. Also this increases elasticity and reduces the load on the weld.

The object according to the invention is furthermore achieved through a method for producing a ball pin of this type in which a hollow cylinder is welded to the ball to form a shaft.

Thus it is preferred in particular when grooves are applied to the inner wall of the shaft so that the grooves extend parallel to the rotation axis of the shaft.

Thus it is preferred in particular when the depth of the grooves is configured greater than half the wall thickness of the shaft.

Thus preferably the grooves are configured with a semi circular cross section.

Thus it is preferred in particular when the grooves are applied over almost the entire length of the shaft.

The present invention is subsequently described in more detail with reference to embodiments illustrated in drawing figures, wherein:

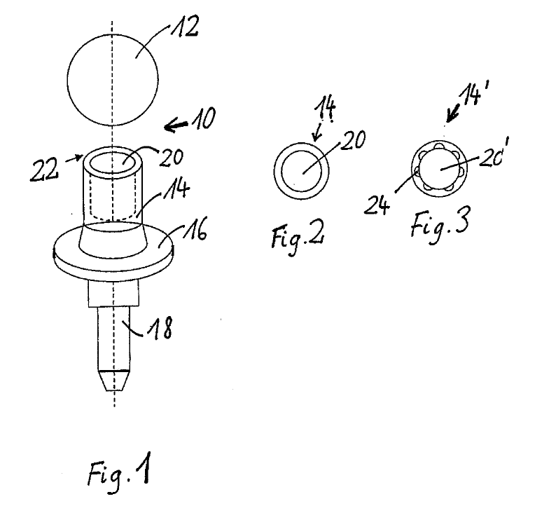

FIG. 1 illustrates a perspective exploded view of a welded ball pin according to the invention;

FIG. 2 illustrates a sectional view of the shaft of the welded ball pin of FIGS. 1; and

FIG. 3 illustrates another embodiment of the shaft for a welded ball pin according to the invention.

FIG. 1 illustrates a perspective exploded view of a welded ball pin according to the invention (before welding ball and shaft together).

The welded ball pin 10 according to the invention includes a ball 12 which is welded onto a shaft 14. The shaft 14 then transitions into a force induction component 16 and an outer thread support 18. These components are not described in detail herein, since they can correspond to the prior art embodiments and do not contribute substantially to the object of the present invention.

According to the invention, however, the shaft 14 is configured as a hollow cylinder with an inner cylindrical cavity 20. The weld between the ball 12 and the shaft 14 is thus only performed in the annular portion 22 in which the hollow cylindrical shaft 14 contacts the ball 12. In spite of that the present configuration is much more durable than the prior art in which a shaft 14 from solid bar stock is provided. According to the invention the shaft 14 based on its configuration as a hollow cylinder namely includes substantial elasticity which helps to substantially reduce the loading of the ball 12 and the shaft 14.

FIG. 2 illustrates a sectional view of the shaft 14, wherein the concentric inner cavity 20 is clearly discernable.

FIG. 3 illustrates another configuration of the shaft 14′ according to the invention in which the inner enveloping surface of the hollow cylindrical shaft 14′ is provided with grooves 24 extending parallel to the rotation axis of the shaft 14′.

In order to provide particularly good elasticity for the shaft 14′ and thus a particularly strong unloading of the weld between the ball 12 and the shaft 14′ it is preferable for the depth of the grooves 24 to be greater than half the wall thickness of the hollow cylindrical shaft 14′.

It is preferable in particular for the grooves 24 to include a semi circular cross section. This simplifies fabrication and reduces peak tensions in the wall of the shaft 14′ when the shaft 14′ receives loads of the weld between the ball 12 and the shaft 14′ in a spring elastic manner.

Thus it is preferable in particular when the grooves 24 extend almost over the entire length of the hollow cylindrical shaft 14′. The length of the grooves 24, however, can be selected according to production requirements to a large extent without having to cope with large reductions in the elasticity of the shaft 14′, wherein the elasticity is desired according to the invention.

Thus, a welded ball pin 10 is provided which on the one hand has lower weight than prior art ball pins and on the other hand provides a discernable stress reduction between the ball 12 and the shaft 14, 14′.

1-10. (canceled)

11. A welded ball pin comprising: a shaft on which a completely closed ball is welded, wherein the shalt is configured as a hollow cylinder and an inner wall of the shaft is provided with grooves extending parallel to a rotation axis of the. shaft.

12. The welded ball pin according to claim 11, wherein a depth of the grooves is greater than half a wall thickness of the hollow cylindrical shaft.

13. The welded ball pin according to claim 11, wherein the grooves have a hollow cylindrical cross section.

14. The welded ball pin according to claim 12, wherein the grooves have a hollow cylindrical cross section.

15. The welded ball pin according to claim 11, wherein the grooves extend almost over the entire length of the hollow cylindrical shaft.

16. The welded ball pin according to claim 12, wherein the grooves extend almost over the entire length of the hollow cylindrical shaft.

17. The welded ball pin according to claim 13, wherein the grooves extend almost over the entire length of the hollow cylindrical shaft.

18. The welded ball pin according to claim 14, wherein the grooves extend almost over the entire length of the hollow cylindrical shaft.

19. A method for producing a ball pin including a completely closed ball and a shall, wherein the method comprises the following steps: welding a hollow cylinder to a ball as a shaft and disposing grooves extending parallel to a rotation axis of the shaft at an inner wall of the

20. The method according to claim 19, wherein a depth of the grooves is configured greater than half a wall thickness of the shaft.

21. The method according to claim 19, wherein the grooves are configured with a semi circular cross section.

22. The method according to claim 20, wherein the grooves are configured with a semi circular cross section.

23. The method according to claim 19, wherein the grooves are applied almost over an entire length of the shaft.

24. The method according to claim 20, wherein the grooves are applied almost over an entire length of the shaft.

25. The method according to claim 21, wherein the grooves are applied almost over an entire length of the shaft.

26. The method according to claim 22, wherein the grooves are applied almost over an entire length of the shaft
